(19) United States
(12) Patent Application Publication
(10) Pub. No.: US 2014/0203786 A1
(43) Pub. Date: Jul. 24, 2014

(54) POWER SUPPLY APPARATUS AND POWER SUPPLY CONTROL APPARATUS

(71) Applicant: Kabushiki Kaisha Toshiba, Tokyo (JP)

(72) Inventors: Takeshi Oosawa, Kashiwazaki-shi (JP); Shinichiro Kosugi, Yokohama-shi (JP); Manabu Murakami, Kashiwazaki-shi (JP); Kazuto Kuroda, Tokyo (JP); Masahiro Sekino, Tokyo (JP); Takashi Sudo, Tokyo (JP); Hideaki Ohsawa, Tokyo (JP); Ryo Okabe, Tokyo (JP)

(73) Assignee: Kabushiki Kaisha Toshiba, Tokyo (JP)

(21) Appl. No.: 14/158,442

(22) Filed: Jan. 17, 2014

(30) Foreign Application Priority Data
Jan. 22, 2013 (JP) 2013-009550
Jan. 22, 2013 (JP) 2013-009579

(51) Int. Cl. H02J 7/00

(52) U.S. Cl. CPC H02J 7/0031
USPC 320/136; 320/137

(57) ABSTRACT

According to one embodiment, a power supply apparatus includes a battery assembly, a fuse element, a switch unit, and a control unit. The fuse element is connected between the battery assembly and a load unit driven by being supplied with power from the battery assembly. The switch unit is connected in parallel to the load unit. The control unit causes, when an over voltage of at least one of the battery assembly and the load unit is detected, the switch unit to be in an ON state, provides an over current to flow from the battery assembly to the fuse element, and fusing the fuse element.

### CROSS-REFERENCE TO RELATED APPLICATIONS

This application is based upon and claims the benefit of priority from Japanese Patent Application No. 2013-009550, filed on Jan. 22, 2013 and Japanese Patent Application No. 2013-009579, filed on Jan. 22, 2013, the entire contents of which are incorporated herein by reference.

### FIELD

Embodiments described herein relate generally to a power supply apparatus and a power supply control apparatus.

### BACKGROUND

For a system that prevents overcharge, overdischarge, and the like of an battery assembly, there has been used a technique in which an interrupter element such as a relay is disposed in a main power supply system supplying power to the battery assembly, and, when an over current is generated due to the overcharge or overdischarge of the battery assembly, the main power supply system is cut off from an external load using the interrupter element.

However, according to the technique in which the interrupter element is disposed in the main power supply system, if a current flowing from the battery assembly to an external load is large, the size of the interrupter element needs to be large. As a result, the interrupter element cannot be housed in the main power supply system. Further, the cost of the main power supply system becomes high. Still further, a current flowing through the primary coil of the relay is caused to increase, and as a result, the power consumption in the relay becomes large. Still further, it becomes necessary to provide a mechanism for limiting the current flowing through the primary coil of the relay for when the variation width of a voltage of the battery assembly is large.

In a battery system having a secondary battery that supplies power to a load unit such as an inverter motor of an electric forklift, a relay that cuts off the supply of power from the secondary battery to the load unit during a period in which the driving of the load unit has been stopped is disposed. In addition, in the battery system, a pre-charging circuit that applies a voltage to a load unit-side terminal connected to a secondary battery-side terminal of the relay before driving of the load unit is disposed, and the rechargeable-side terminal and the load unit-side terminal of the relay are configured to be at the same electric potential. Accordingly, when the relay is in the ON state so as to start the driving of the load unit, an inrush current does not flow into the secondary battery-side terminal and the load unit-side terminal of the relay, whereby the welding of the relay is prevented.

However, in the conventional battery system, when a pre-charging circuit is not arranged, the secondary battery-side terminal and the load unit-side terminal of the relay cannot be configured to be at the same electric potential before the load unit is driven, and accordingly, reduction of size and weight of the battery system could not be achieved.

### BRIEF DESCRIPTION OF THE DRAWINGS

FIG. 1 is a block diagram illustrating an overview of a configuration of an electrical system of an electric forklift for when a battery assembly system is mounted in an electric forklift, according to an embodiment;

FIG. 2 is a block diagram illustrating a detailed configuration of an electrical system of a battery pack device according to the embodiment; and

FIG. 3 is a diagram illustrating an example of the connection of a connector of a wiring that supplies power to an inverter motor in the battery pack device according to the embodiment.

### DETAILED DESCRIPTION

In general, according to one embodiment, a power supply apparatus comprises a battery assembly, a fuse element, a switch unit, and a control unit. The fuse element is connected between the battery assembly and a load unit driven by being supplied with power from the battery assembly. The switch unit is connected in parallel to the load unit. The control unit causes, when an over voltage of at least one of the battery assembly and the load unit is detected, the switch unit to be in an ON state, provides an over current to flow from the battery assembly to the fuse element, and fusing the fuse element.

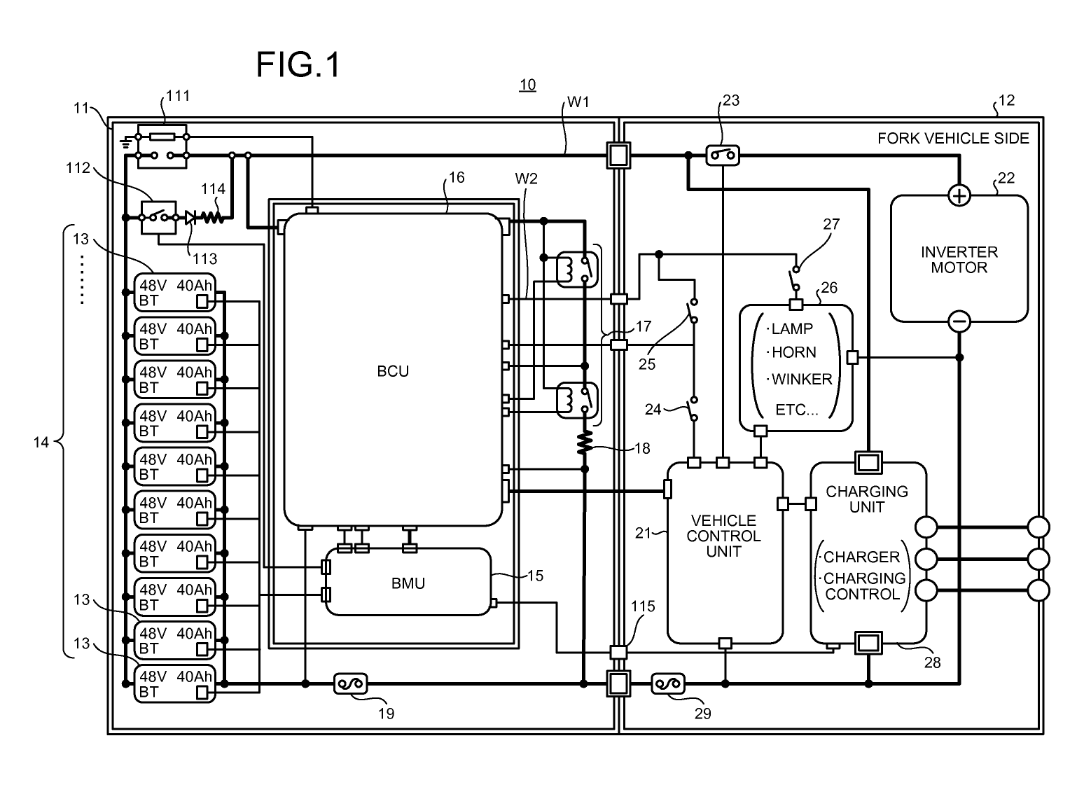

FIG. 1 is a block diagram that illustrates an overview of the configuration of an electrical system of an electric forklift of when a battery assembly system according to this embodiment is installed in the electric forklift. When broadly divided, an electrical system 10 of the electric forklift is equipped with: a battery pack device 11 (an example of a power supply apparatus or a power supply control apparatus) that supplies power for driving the electric forklift; and a forklift electrical system unit 12 that performs an operation of charging the battery pack device 11 and an operation of receiving power from the battery pack device 11.

The battery pack device 11 comprises a battery pack module 14, a battery management unit (BMU) 15, a battery control unit (BCU) 16, a power shutoff control relay unit 17, a current limiting resistor 18, a fuse element 19, a relay 111, a molded case circuit breaker (MCCB) 112, a reverse current preventing diode 113, a current limiting resistor 114, and an output terminal 115. In the battery pack module 14, a plurality of battery assembly modules 13 are connected in parallel with each other. The battery management unit (BMU) 15 controls the charging and discharging of each battery assembly module 13. The battery control unit (BCU) 16 performs overall control of the battery pack device 11. The power shutoff control relay unit 17 becomes an ON state when an over voltage of the battery pack module 14 is detected. The current limiting resistor 18 prevents an inrush current flowing when the power shutoff control relay unit 17 is in the On state. The fuse element 19 fuses when the power shutoff control relay unit 17 operates and an over current flows from the battery pack module 14. The relay 111 shuts off the supply of power from the battery pack module 14 to an inverter motor 22 to be described later when a key switch 25 (to be described later) is in the OFF state by an operator performing a key operation. The molded case circuit breaker (MCCB) 112 is used for preventing the fusion of the relay 111 due to an inrush current from the battery pack module 14 to the inverter motor 22. The reverse current preventing diode 113 prevents a reverse flow of the current from the forklift electrical system unit 12 to the battery pack module 14. The output terminal 115 outputs a charge control signal used for permitting charging using a charging unit 28 included in the forklift electrical system unit 12.

The forklift electrical system unit 12 comprises a vehicle control unit 21, an inverter motor 22, a contactor 23, an interlock switch 24, a key switch 25, an auxiliary machine group 26, an auxiliary machine group switch 27, a charging unit 28, and a fuse element 29. The vehicle control unit 21 controls the overall operation of the forklift electrical system unit 12. The inverter motor 22 is driven under the control of the vehicle control unit 21. The contactor 23 supplies power from the battery pack device 11 to the inverter motor 22 under the control of the vehicle control unit 21. The interlock switch 24 becomes an ON state an operator at a correct operation position is detected (for example, a correct seated position). The key switch 25 becomes an ON state by an operator's key operation. The auxiliary machine group 26 comprises auxiliary machines such as a head lamp, a warning horn, and a blinker (traffic indicator). The auxiliary machine group switch 27 supplies driving power to the auxiliary machine group 26 in accordance with an operator's key operation. The charging unit 28, which an external commercial power supply (for example, a three-phase AC power supply) is connected to, charges the battery pack module 14 that configures the battery pack device 11 in accordance with a charging control signal output from the battery pack device 11. The fuse element 29 fuses due to an over current flowing through the inverter motor 22 when an over voltage is generated.

Here, an overview of the operation of the electrical system 10 of the electric forklift will be described. In a normal operation state, when the operator arrives at the correct operation position, the interlock switch 24 becomes the On state. The auxiliary machine group switch 27 is maintained at the On state all the time, thereby the auxiliary machines such as a head lamp, a warning horn, and a blinker (traffic indicator) can be operated.

Subsequently, when the operator continues the key operation, the key switch 25 becomes the ON state. When the key switch 25 is in the ON state, power is supplied from a second wiring W2 to the vehicle control unit 21. In other words, when the interlock switch 24 and the key switch 25 are in the ON state, the inverter motor 22 is put into a drivable state. Accordingly, the vehicle control unit 21 supplies power to the inverter motor 22 from the battery pack module 14 of the battery pack device 11 through a first wiring W1 with the contactor 23 being in the ON state and supplies power to the auxiliary machine group 26 from the battery pack module 14 of the battery pack device 11 through the second wiring W2 that is a system different from the first wiring W1.

As a result, the inverter motor 22 is put in the driven state, and the electric forklift is driven and is operated by the operator.

In addition, in the charging operation state, an external commercial power supply (for example, a three-phase AC power supply) is connected to the charging unit 28, whereby the battery pack module 14 configuring the battery pack device 11 is charged. In this case, the overall control of the battery pack device 11 is performed by the battery control unit 16, and the control of charging and discharging of the battery assembly module 13 is performed by the battery management unit 15. More specifically, for a predetermined time from when a charging control signal used for permitting the charging of the battery pack module 14 from the battery management unit 15 through the output terminal 115 is input, the charging unit 28 charges the battery pack module 14. In addition, when the battery voltage of the battery pack module 14 reaches a maximum charging voltage, the battery management unit 15 may convert the charging control signal into a signal indicating prohibition of the charging of the battery pack module 14 and output the converted signal from the output terminal 115. Here, the maximum charging voltage is a predetermined voltage at which it is regarded that an overcharge state is reached.

When the operator performs a key operation so as to allow the key switch 25 to be in the OFF state and the driving of the inverter motor 22 is stopped, the battery control unit 16 shuts off the supply of power from the battery pack module 14 to the inverter motor 22 with the relay 111 being in the OFF state. While the driving of the inverter motor 22 is stopped, the MCCB 112 (an example of a short-circuit unit) forms a short circuit between a terminal 111b, which is disposed on the side of the battery pack module 14, and a terminal 111c, which is disposed on the side of the inverter motor 22, of the relay 111 so as to cause the terminal 111b, which is disposed on the side of the battery pack module 14, and the terminal 111c, which is disposed on the side of the inverter motor 22, of the relay 111 to be at the same electric potential. Accordingly, power can be supplied to the auxiliary machine group 26 such as a lamp and a horn.

In addition, when an over voltage is generated in at least one of the first wiring W1 (inverter motor 22) and the battery assembly module 13 for any reason, the battery control unit 16 sets two relay units configuring the power shutoff control relay unit 17 to be in the ON state. When the two relay units configuring the power shutoff control relay unit 17 are put in the ON state, the fuse element 19 fuses in accordance with an over current that flows in accordance with the ON state of the relay units.

As a result, the supply of power to the battery control unit 16 is shut off, and the two relay units configuring the power shutoff control relay unit 17 are put in the OFF state again. Accordingly, a contactor used for cutting off an over voltage or the like does not need to be arranged, and thereby, the size and the weight of the battery pack device 11 can be decreased. Therefore, by employing such configuration, the relay 111 and the MCCB 112 can be reduced.

In the configuration of the battery pack device 11, when a case is considered in which a lead storage battery of a maximum charging voltage 60 V and a minimum discharging voltage 30 V is replaced with the battery assembly module 13, for example, it is desirable that the battery assembly module 13 serves as a lithium ion battery having the capacity of 48 V and 400 Ah. Thus, in this embodiment, the battery assembly module 13 is configured by using a lithium ion battery of 20 Ah-2.8 V as the secondary battery.

Here, the configuration of the lithium ion battery that configures the battery pack device 11 will be described. Conventionally, in a middle-size or large-size device having an average operating voltage using a lead storage battery as 48 V, it is required that the battery is operated up to a maximum charging voltage of 60 V and a minimum discharging voltage of about 30 V of the lower-limit capacity of the motor.

When the lead storage battery is replaced with a conventionally representative lithium ion battery and the maximum charging voltage is adjusted, the minimum discharging voltage is about 42 V, and the operating voltage range is different from the required range, whereby the lead storage battery cannot be simply replaced with the lithium ion battery.

Thus, in this embodiment, a lithium ion battery is designed such that the operating voltage range is the same as that of a conventional lead storage battery, and the battery pack device 11 is configured by using the lithium ion battery. In other words, a lithium ion battery having a lower-limit state of charge (SOC) corresponding to a discharge termination voltage equivalent to that of the lead storage battery is designed, and the battery pack device 11 is configured thereby. As a result, according to the battery pack device 11 of this embodiment, the lead storage battery can be completely replaced.

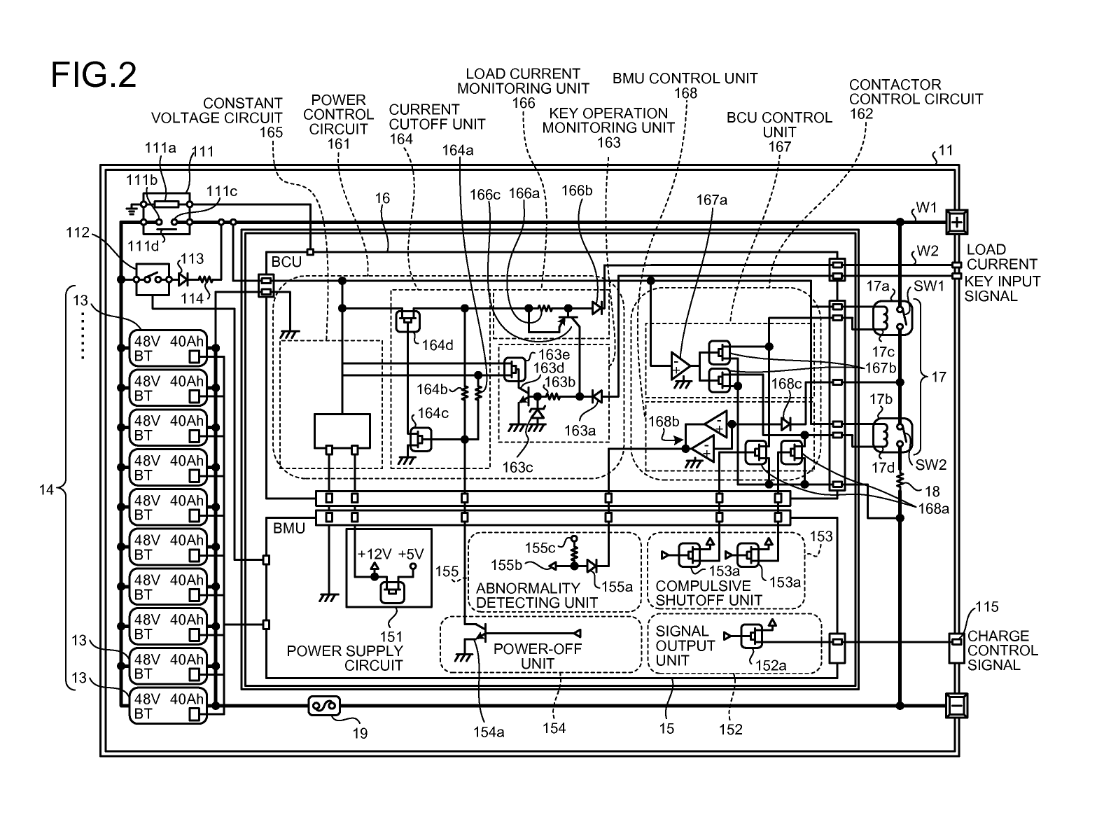

FIG. 2 is a block diagram that illustrates a detailed configuration of an electrical system of the battery pack device according to this embodiment. The battery pack device 11, as described above, comprises: the battery pack module 14; the battery management unit 15; the battery control unit 16; the power shutoff control relay unit 17; the current limiting resistor 18; the fuse element 19; the relay 111; the MCCB 112; the reverse current preventing diode 113; the current limiting resistor 114; and the output terminal 115.

The relay 111 is connected between the battery pack module 14 (an example of the secondary battery) and the inverter motor 22 (an example of the main load unit) that is driven by being supplied with power from the battery pack module 14. Then, under the control of the battery control unit 16, when the operator performs a key operation so as to allow the key switch 25 to be in the OFF state and the driving of the inverter motor 22 is stopped, the relay 111 shuts off the supply of power from the battery pack module 14 to the inverter motor 22.

More specifically, the relay 111 includes a primary coil 111a, the terminal 111b that is connected to the side of the battery pack module 14, the terminal 111c that is connected to the side of the inverter motor 22, and a switch 111d. When the interlock switch 24 and the key switch 25 are in the ON state and the inverter motor 22 is in a drivable state, the primary coil 111a is applied with a voltage from the battery control unit 16, and allows the switch 111d to be put in the ON state. Accordingly, the terminal 111b disposed on the side of the battery pack module 14 and the terminal 111c disposed on the side of the inverter motor 22 are connected together, whereby power is supplied to the inverter motor 22 from the battery pack module 14.

On the other hand, when the key switch 25 is put in the OFF state and the driving of the inverter motor 22 is stopped, the application of the voltage to the primary coil 111a according to the battery control unit 16 is stopped, and the primary coil 111a allows the switch 111d to be in the OFF state. Accordingly, the connection between the terminal 111b disposed on the side of the battery pack module 14 and the terminal 111c disposed on the side of the inverter motor 22 is interrupted, whereby the supply of power from the battery pack module 14 to the inverter motor 22 is shut off.

The MCCB 112 is connected to the relay 111 in parallel therewith, and forms a short circuit between the terminal 111b disposed on the side of the battery pack module 14 and the terminal 111c disposed on the side of the inverter motor 22 while the driving of the inverter motor 22 has been stopped. Accordingly, while the driving of the inverter motor 22 has been stopped, the terminal 111b disposed on the side of the battery pack module 14 and the terminal 111c disposed on the side of the inverter motor 22 can be maintained to be at the same electric potential.

As will be described later, according to this embodiment, the MCCB 112 supplies power from the battery pack module 14 to the auxiliary machine group 26 while the driving of the inverter motor 22 has been stopped, and accordingly, there are cases in which the terminal 111b disposed on the side of the battery pack module 14 and the terminal 111c disposed on the side of the inverter motor 22 cannot be maintained to be at the same electric potential. In such cases, while the driving of the inverter motor 22 has been stopped, the MCCB 112 maintains an electric potential difference between the terminals 111b and 111c that are connected by the relay 111 to be a predetermined value or less by applying the battery voltage of the battery pack module 14 to the terminal 111c. Here, the predetermined value is a value of less than a potential difference at which an inrush current flows into the terminals 111b and 111c while the key switch 25 is put in the ON state, the inverter motor 22 is put in a drivable state, and the switch 111d is put in the ON state.

In this embodiment, while the MCCB 112 is used as an example of the short-circuit unit that forms a short circuit between the terminals 111b and 111c while the driving of the inverter motor 22 has been stopped, any unit can be used which forms a short circuit between the terminal 111b disposed on the side of the battery pack module 14 and the terminal 111c disposed on the side of the inverter motor 22 while the driving of the inverter motor 22 has been stopped. For example, instead of the MCCB 112, while the driving of the inverter motor 22 has been stopped, a short circuit may be formed between the terminal 111b disposed on the side of the battery pack module 14 and the terminal 111c disposed on the side of the inverter motor 22 by connecting a fuse or the like to the relay 111 in parallel therewith.

In the conventional battery pack device 11, before the inverter motor 22 is driven, by applying a voltage to the terminal 111c of the relay 111 that is disposed on the side of the inverter motor 22 using a pre-charging circuit, the terminal 111b disposed on the side of the battery pack module 14 and the terminal 111c disposed on the side of the inverter motor 22 are allowed to be at the same electric potential. However, when the pre-charging circuit is disposed inside the battery pack device 11, the size and the weight of the battery pack device 11 cannot be decreased.

Thus, in this embodiment, by forming a short circuit between the terminals 111b and 111c while the driving of the inverter motor 22 has been stopped, the MCCB 112 maintains the terminals 111b and 111c to be at the same electric potential (or an electric potential difference between the terminals 111b and 111c is maintained to be a predetermined value or less). Accordingly, the terminals 111b and 111c can be maintained at the same electric potential without arranging a pre-charging circuit while the driving of the inverter motor 22 has been stopped, whereby the size and the weight of the battery pack device 11 can be decreased.

In addition, while the supply of power to the inverter motor 22 from the battery pack module 14 through the relay 111 has been stopped, the MCCB 112 supplies power delivered from the battery pack module 14 to the auxiliary machine group 26 (an example of a sub load unit). In this embodiment, when the key switch 25 is in the OFF state and the auxiliary machine group switch 27 and the interlock switch 24 are in the ON state, the MCCB 112 supplies power delivered from the battery pack module 14 to the auxiliary machine group 26 through the second wiring W2. Accordingly, while the driving of the inverter motor 22 has been stopped, the operation of the auxiliary machine group 26 can be performed as long as the auxiliary machine group switch 27 is in the ON state.

Furthermore, when an over voltage is generated in the battery pack module 14, the MCCB 112 shuts off the supply of the power from the battery pack module 14 to the auxiliary machine group 26. Accordingly, while the driving of the inverter motor 22 has been stopped, when an over voltage is generated in the battery pack module 14, an over current flows through the auxiliary machine group 26, whereby the auxiliary machine group 26 is prevented from being damaged.

In addition, when an over discharge state of the battery pack module 14 is detected by the battery management unit 15, a trip signal directing the shutting off of the supply of power from the battery management unit 15 to the auxiliary machine group 26 is input to the MCCB 112, and the MCCB 112 shuts off the supply of power from the battery pack module 14 to the auxiliary machine group 26. Accordingly, it can be prevented that the battery pack module 14 is damaged due to an over discharge state of the battery pack module 14 in accordance with the power consumption of the auxiliary machine group 26 while the driving of the inverter motor 22 has been stopped.

Furthermore, in this embodiment, when an over voltage is not generated in the battery pack module 14 or when a trip signal is not input from the battery management unit 15, the MCCB 112 is maintained at the ON state and supplies power from the battery pack module 14 to the auxiliary machine group 26. However, it may be configured such that power is supplied from the battery pack module 14 to the auxiliary machine group 26 as the operator manually sets the MCCB 112 to the ON state.

The output terminal 115 outputs a charge control signal that is output from the battery management unit 15 to the charging unit 28 included in the forklift electrical system unit 12. More specifically, when the battery voltage of the battery pack module 14 is lower than the maximum charging voltage, the output terminal 115 outputs a charge control signal of a high level, which is used for permitting the charging of the battery pack module 14, to the charging unit 28. Then, when the battery voltage of the battery pack module 14 is the maximum charging voltage, the output terminal 115 can output a charge control signal, of which the level has been converted into a low level, used for prohibiting the charging of the battery pack module 14.

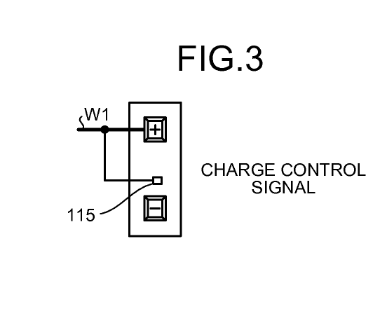

When the secondary battery used in the battery assembly module 13 of the battery pack module 14 is a lead storage battery, the output terminal 115 continuously outputs a charge control signal used for permitting the charging of the battery pack module 14. FIG. 3 is a diagram that illustrates an example of the connection of a connector of a wiring that supplies power to the inverter motor in the battery pack device according to this embodiment. In this embodiment, when the secondary battery used in the battery assembly module 13 of the battery pack module 14 is a lead storage battery, as illustrated in FIG. 3, the connector of the first wiring W1 that supplies power to the inverter motor 22 is connected to the output terminal 115. Accordingly, a charge control signal of the high level that is used for permitting the charging of the battery pack module 14 is continuously output from the output terminal 115.

On the other hand, when the secondary battery used in the battery assembly module 13 is a lithium ion battery, the connector of the wiring that transmits the charge control signal output from the battery management unit 15 is connected to the output terminal 115. Accordingly, when the battery voltage of the battery pack module 14 is at the maximum charging voltage, the charging mode according to the charging unit 28 can be switched from constant current charging to constant voltage charging, and accordingly, the battery pack module 14 can be prevented from being charged over the maximum charging voltage.

In the battery assembly system using a lead storage battery, in order to improve the driving capability (for example, a time during which power can be supplied from the battery assembly system, the magnitude of power that can be supplied from the battery assembly system, and the like), it is desirable to replace the lead storage battery with a lithium ion battery. However, since the charging characteristics of the lead storage battery and those of the lithium ion battery are different from each other, in order to allow the lead storage battery to be replaceable with the lithium ion battery, a charging method such as the setting of a charging voltage needs to be changed in accordance with the type of the battery used in the battery assembly system, and there is a problem in that it is not easy to replace the battery with a lead storage battery or a lithium ion battery.

Thus, in this embodiment, by converting the charge control signal for permitting the charging of the battery pack module 14 into a signal for prohibiting the charging of the battery pack module 14 and allowing the output terminal 115 to output the converted signal, even when the secondary battery of the battery pack module 14 is replaced with a secondary battery having different charging characteristics, the charging of the battery pack module 14 can be performed by using the same charging unit 28 in accordance with charging characteristics.

In addition, when the replacement is made with a secondary battery (for example, a lead storage battery or the like) for which the charge control signal for prohibiting the charging of the battery pack module 14 does not need to be output, the charging can be performed with a charging method that is appropriate to the charging characteristics of the replaced secondary battery only by connecting the connector of the signal (in this embodiment, the signal output from the connector of the first wiring W1) for continuously maintaining the state (high-level state) for permitting the charging of the battery pack module 14 to the output terminal 115.

The fuse element 19 is connected between the battery pack module 14 (an example of the battery assembly) and the inverter motor 22 (an example of the load unit) that is driven by being supplied with power delivered from the battery pack module 14. In this embodiment, the fuse element 19 fuses when a rated current (500 Ah) or more flows through it.

The power shutoff control relay unit 17 is an example of a switch unit that is connected to the inverter motor 22 in parallel. In this embodiment, the power shutoff control relay unit 17 includes two relays of first and second relays 17a and 17b (examples of the switch) that are connected in series. More specifically, the power shutoff control relay unit 17 includes the first relay 17a that is connected to the high electric potential side of the battery pack module 14 and the second relay 17b that is connected to the low electric potential side of the battery pack module 14.

The first relay 17a includes a primary coil 17c that causes a drive current to flow in accordance with a drive signal supplied from the battery control unit 16 and a switch SW1 that connects a high electric potential-side terminal and a low electric potential-side terminal of the first relay 17a. In addition, the second relay 17b includes a primary coil 17d that causes a drive current to flow in accordance with a drive signal supplied from the battery control unit 16 and a switch SW2 that connects a high electric potential-side terminal and a low electric potential-side terminal of the second relay 17b. Furthermore, a drive device (PMOS transistor 168a) of the primary coil 17c of the first relay 17a is connected to the battery pack module 14 through the fuse element 19.

As described above, by connecting the drive device (PMOS transistor 168a) that drives the primary coils 17c and 17d included in the first and second relays 17a and 17b to the battery pack module 14 through the fuse element 19, when the fuse element 19 fuses due to the over current flow through at least one of the inverter motor 22 and the battery assembly module 13, a voltage is not applied to the primary coils 17c and 17d, and the switches SW1 and SW2 are in the OFF state. Accordingly, over currents are prevented from continuously flowing into the first and second relays 17a and 17b, and therefore, the battery pack module 14 can be prevented from being in the over discharge state due to continuous operations of the first and second relays 17a and 17b.

The current limiting resistor 18 is connected between the power shutoff control relay unit 17 and the fuse element 19, and prevents an inrush current from flowing into the first and second relays 17a and 17b when the power shutoff control relay unit 17 becomes the ON state. In this embodiment, although the current limiting resistor 18 is used, any resistor that can prevent an inrush current from flowing into the first and second relays 17a and 17b may be used, and, for example, wiring resistance may be used as the current limiting resistor 18.

Next, a detailed configuration of the battery control unit 16 will be described. The battery control unit 16 performs overall control of the battery pack device 11 and, when largely divided, includes a power control circuit 161 that controls the supply of power to the forklift electrical system unit 12 and a contactor control circuit 162 that controls the power shutoff control relay unit 17.

The power control circuit 161 includes a key operation monitoring unit 163, a current cutoff unit 164, a constant voltage circuit 165, and a load current monitoring unit 166. The key operation monitoring unit 163 detects whether the key switch 25 is put in the ON state by an operator's key operation. The current cutoff unit 164 controls the supply of power to the auxiliary machine group 26 after the key switch 25 is put in the ON state. The constant voltage circuit 165 converts the battery voltage (in this embodiment, 48 V) of the battery pack module 14 into a drive voltage (in this embodiment, 12 V) for driving the battery control unit 16 and the battery management unit 15, and applies the converted voltage to the battery control unit 16 and the battery management unit 15. The load current monitoring unit 166 detects a current (hereinafter, referred to as a load current) flowing to the auxiliary machine group 26 through the second wiring W2.

The key operation monitoring unit 163 includes: an NPN transistor 163d, a PMOS transistor 163e, a Zener diode 163c, a current limiting resistor 163b, and a reverse current preventing diode 163a. The NPN transistor 163d is put in the ON state when the key switch 25 is put in the ON state and a key input signal of the high level is input. The PMOS transistor 163e is put in the ON state by applying a low level to the gate when the NPN transistor 163d is put in the ON state. The Zener diode 163c is used for acquiring a constant voltage applied to the base of the NPN transistor 163d. The reverse current preventing diode 163a prevents a reverse flow of the current to the forklift electrical system unit 12. In addition, when the load current is detected by the load current monitoring unit 166 to be described later after the key switch 25 is put in the OFF state, the high level is applied to the base of the NPN transistor 163d by the load current monitoring unit 166, and the NPN transistor 163d is put in the ON state.

In addition, when the key switch 25 is in the OFF state, the key operation monitoring unit 163 allows the relay 111 to become the OFF state, thereby shutting off the supply of power from the battery pack module 14 to the inverter motor 22. In this embodiment, when the key switch 25 is in the OFF state, the key operation monitoring unit 163 stops the application of a voltage to the primary coil 111a of the relay 111, thereby allowing the relay 111 to be in the OFF state.

The current cutoff unit 164 comprises an NMOS transistor 164c, a PMOS transistor 164d, and a current limiting resistors 164a and 164b. The NMOS transistor 164c becomes the ON state by being applied with the high level at the gate when the PMOS transistor 163e of the key operation monitoring unit 163 becomes the ON state. The PMOS transistor 164d becomes the ON state by being applied with the low level at the gate when the NMOS transistor 164c becomes the ON state.

The load current monitoring unit 166 comprises a PNP transistor 166c, a current limiting resistor 166a, and a reverse current preventing diode 166b. The PNP transistor 166c becomes the ON state by being applied with the low level at the base when the auxiliary machine group switch 27 becomes the ON state and the load current flows into the auxiliary machine group 26. The reverse current preventing diode 166b prevents a reverse flow of the current from the auxiliary machine group 26 to the battery pack device 11.

The contactor control circuit 162 includes: a BCU control unit 167 and a BMU control unit 168. The BCU control unit 167 operates the power shutoff control relay unit 17 when the generation of an over voltage is detected in the inverter motor 22 and the battery pack module 14. The BMU control unit 168 operates the power shutoff control relay unit 17, and notifies the battery management unit 15 of the operation of the power shutoff control relay unit 17 when the generation of an over voltage is detected in the battery assembly module 13.

The BCU control unit 167 comprises an operational amplifier 167a and a PMOS transistor 167b. The operational amplifier 167a applies the low level to the gate of a PMOS transistor 167b when the battery voltage of the battery pack module 14 is at greater than or equal to a predetermined voltage at which an over voltage is reached. The PMOS transistor 167b becomes the ON state when the low level is applied to the gate by the operational amplifier 167a.

The BMU control unit 168 comprises a PMOS transistor 168a that becomes the ON state by being applied with the low level at the gate by the battery management unit 15 when the battery assembly voltage of the battery assembly module 13 is detected to be out of an battery assembly voltage range that is the predetermined voltage range reaching an over voltage by the battery management unit 15.

In addition, the BMU control unit 168 comprises: a detection circuit 168b that detects a voltage between the first and second relays 17a and 17b; and a diode 168c that prevents an inflow of the current of the detection circuit 168b from the power shutoff control relay unit 17. In this embodiment, the detection circuit 168b detects high impedance when the first and second relays 17a and 17b are in the OFF state, detects a low level when the first and second relays 17a and 17b are in the ON state, and transmits a result of the detection to the battery management unit 15.

Next, a detailed configuration of the battery management unit 15 will be described. The battery management unit 15 is driven by being supplied with power of the battery pack module 14 through the battery control unit 16, and detects the battery voltage of the battery pack module 14, the cell voltage of the secondary battery included in the battery assembly module 13, and a battery assembly voltage of the battery assembly module 13.

In this embodiment, the battery management unit 15 comprises a power supply circuit 151, a signal output unit 152, a compulsive shutoff unit 153, a power-off unit 154, and an abnormality detecting unit 155. The power supply circuit 151 is applied with a voltage by the constant voltage circuit 165 of the battery control unit 16, and supplies power of the battery pack module 14 to each unit of the battery management unit 15. The signal output unit 152 can output a charge control signal for prohibiting the charging of the battery pack module 14. The compulsive shutoff unit 153 applies the low level to the gate of the PMOS transistor 168a of the BMU control unit 168 when the battery assembly voltage of the battery assembly module 13 is out of the battery assembly voltage range, and the generation of an over voltage is detected. The power-off unit 154 shuts off the supply of power to the auxiliary machine group 26 by controlling the current cutoff unit 164 when the cell voltage of the secondary battery included in the battery assembly module 13 is at less than or equal to a discharge termination cell voltage, which is a predetermined voltage at which it is regarded that an over discharge state is reached. The abnormality detecting unit 155 detects an abnormality of the power shutoff control relay unit 17 based on the result of the detection of the voltage between the first and second relays 17a and 17b that is acquired by the detection circuit 168b.

The signal output unit 152 includes a PMOS transistor 152a that becomes the ON state by being applied with the low level at the gate when the battery voltage of the battery pack module 14 is at the maximum charging voltage.

The compulsive shutoff unit 153 includes a PMOS transistor 153a that becomes the ON state by being applied with the low level at the gate when the battery assembly voltage of the battery assembly module 13 is outside the battery assembly voltage range and an over voltage is detected.

The power-off unit 154 includes an NPN transistor 154a that becomes the OFF state by being applied with the low level at the base when the cell voltage of the secondary battery included in the battery assembly module 13 is at less than or equal to the discharge termination cell voltage. In addition, when the cell voltage of the secondary battery of the battery assembly module 13 is at less than or equal to the discharge termination cell voltage and an over discharge state is detected, the power-off unit 154 (an example of a detection unit) shuts off the supply of power to the auxiliary machine group 26 from the battery pack module 14 by inputting the trip signal to the MCCB 112.

The abnormality detecting unit 155 comprises a diode 155a, an output unit 155b, and a terminal 155c. The diode 155a prevents an inflow of the current from the battery control unit 16. A result of the detection of a voltage that is acquired by the detection circuit 168b is output to the output unit 155b. A constant voltage for acquiring the result of the detection of a voltage that is acquired by the detection circuit 168b is applied to the terminal 155c. The abnormality detecting unit 155 detects the abnormality of the power shutoff control relay unit 17 by determining whether the terminal 155c is in the state of the low level or the high impedance (in order words, based on the result of the detection of a voltage that is acquired by the detection circuit 168b).

Here, the flow of the operations of the battery control unit 16 and the battery management unit 15 will be described. The operations will be described for a case where an operator performs a key operation, and the key switch 25 is in the ON state. When the key switch 25 is in the ON state, a key input signal of the high level is input from the forklift electrical system unit 12 to the key operation monitoring unit 163 of the battery control unit 16. When the key input signal is at the high level, the key operation monitoring unit 163 causes the relay 111 to be in the ON state, and power is supplied from the battery pack module 14 to the inverter motor 22 through the first wiring W1.

In addition, when the key input signal is at the high level, the NPN transistor 163d of the key operation monitoring unit 163 is in the ON state, and the low level is applied to the gate of the PMOS transistor 163e of the key operation monitoring unit 163, and accordingly, the PMOS transistor 163e is in the ON state as well.

When the PMOS transistor 163e becomes the ON state, the high level is applied to the gate of the NMOS transistor 164c of the current cutoff unit 164, and accordingly, the NMOS transistor 164c becomes the ON state. When the NMOS transistor 164c becomes the ON state, the low level is applied to the gate of the PMOS transistor 164d of the current cutoff unit 164, and accordingly, the PMOS transistor 164d becomes the ON state as well. When the PMOS transistor 164d becomes the ON state, power is supplied from the battery pack module 14 to the auxiliary machine group 26 through the second wiring W2.

In addition, when the PMOS transistor 163e becomes the ON state, the battery voltage is applied from the battery pack module 14 to the constant voltage circuit 165. By converting the battery voltage of the battery pack module 14 into a drive voltage for the battery control unit 16 and the battery management unit 15 and applying the converted drive voltage to the units of the battery control unit 16 and the battery management unit 15, the constant voltage circuit 165 supplies power to the battery control unit 16 and the battery management unit 15.

When the PMOS transistor 164d of the current cutoff unit 164 becomes the ON state, and the power is started to be supplied to the auxiliary machine group 26, the low level is applied to the base of the PNP transistor 166c of the load current monitoring unit 166, whereby the PNP transistor 166c becomes the ON state. When the PNP transistor 166c becomes the ON state, the auxiliary machine group switch 27 becomes the OFF state, and until the load current does not flow through the auxiliary machine group 26, the high level is continuously applied to the base of the NPN transistor 163d of the key operation monitoring unit 163, and the supply of power from the battery pack module 14 to the auxiliary machine group 26 is maintained. In other words, when the key input signal is at the high level and the supply of power to the auxiliary machine group 26 is started once, even when the level of the key input signal becomes the low level thereafter, the load current monitoring unit 166 continues the supply of power to the auxiliary machine group 26.

When a voltage is applied by the constant voltage circuit 165, the power supply circuit 151 of the battery management unit 15 supplies power to each unit of the battery management unit 15. Then, the battery management unit 15 starts the detection of the battery voltage of the battery pack module 14 and the detection of the cell voltage of the secondary battery included in the battery assembly module 13.

While power is supplied to the forklift electrical system unit 12, the BCU control unit 167 of the battery control unit 16 detects whether the battery voltage of the battery pack module 14 is at greater than or equal to a predetermined voltage (whether an over voltage is generated in the inverter motor 22). When the battery voltage of the battery pack module 14 is at greater than or equal to the predetermined voltage (when the generation of an over voltage in the inverter motor 22 is detected), the operational amplifier 167a of the BCU control unit 167 applies the low level to the gate of the PMOS transistor 167b of the BCU control unit 167, thereby causing the PMOS transistor 167b to be in the ON state. When the PMOS transistor 167b is put in the ON state, the battery control unit 16 causes the power shutoff control relay unit 17 to be in the ON state so as to allow an over current to flow to the fuse element 19, thereby fusing the fuse element 19.

In addition, while power is supplied to the forklift electrical system unit 12, the compulsive shutoff unit 153 of the battery management unit 15 determines whether the battery assembly voltage of the battery assembly module 13 is outside the battery assembly voltage range (whether an over voltage is generated in the battery assembly module 13). When the battery assembly voltage of the battery assembly module 13 is outside the battery assembly voltage range (when the generation of an over voltage in the battery assembly module 13 is detected), the PMOS transistor 153a of the compulsive shutoff unit 153 is applied with the low level at the gate to be in the ON state. When the PMOS transistor 153a is put in the ON state, the battery management unit 15 causes the power shutoff control relay unit 17 to be in the ON state and allows an over current to flow through the fuse element 19, thereby fusing the fuse element 19. In other words, when an over voltage is detected in at least one of the inverter motor 22 and the battery assembly module 13, the battery control unit 16 and the battery management unit 15 cause the power shutoff control relay unit 17 to be in the ON state and allows an over current to flow through the fuse element 19, thereby fusing the fuse element 19.

In this embodiment, when the PMOS transistor 167b or 153a is put in the ON state, the battery voltage of the battery pack module 14 is applied to the primary coils 17c and 17d of the first and second relays 17a and 17b, the switches SW1 and SW2 are in the ON state, and an over current flowing through the first wiring W1 flows into the fuse element 19, whereby the fuse element 19 fuses.

Accordingly, when an over voltage is applied to at least one of the inverter motor 22 and the battery assembly module 13, the connection between the battery pack module 14 and the inverter motor 22 can be blocked, whereby the battery pack module 14 can be prevented from being damaged. In addition, since the fuse element 19 is used as a shutoff device that blocks the connection between the battery pack module 14 and the inverter motor 22 when an over voltage is applied, compared to a case where a relay is used as the shutoff device, the size of the battery pack device 11 can be decreased, and the cost and the power consumption thereof can be reduced.

In addition, in this embodiment, the drive device (PMOS transistor 168a) driving the primary coils 17c and 17d is connected to the battery pack module 14 through the fuse element 19. Accordingly, when the fuse element 19 fuses, no voltage is applied to the primary coils 17c and 17d to cause the switches SW1 and SW2 to be in the OFF state, whereby the current is prevented from continuously flowing through the first and second relays 17a and 17b. Accordingly, the battery pack module 14 is not in the over discharge state.

By causing the primary coils 17c and 17d to be alternately in the ON state using the compulsive shutoff unit 153, the abnormality detecting unit 155 makes a failure determination. When a predetermined signal is input from the detection circuit 168b and the terminal 155c has a signal other than the predetermined signal even when the PMOS transistor 153a is put in the OFF state or the ON state, the first and second relays 17a and 17b break down, and accordingly, the abnormality of the power shutoff control relay unit 17 is detected.

On the other hand, even when an over voltage is detected by the BCU control unit 167 and the compulsive shutoff unit 153, and the PMOS transistors 167b and 153a are in the ON state, when the detection circuit 168b is in the high impedance state so as to cause the terminal 155c to have high impedance, both the first and second relays 17a and 17b or only the second relay 17b break down to be put in the OFF state, and accordingly, the abnormality detecting unit 155 detects the abnormality of the power shutoff control relay unit 17. Accordingly, the breakdown of the power shutoff control relay unit 17 can be detected, whereby the safety of the battery pack device 11 can be improved.

In addition, while the power is supplied to the forklift electrical system unit 12, the power-off unit 154 of the battery management unit 15 determines whether the cell voltage of the secondary battery included in the battery assembly module 13 is the discharge termination cell voltage or less. When the cell voltage is at less than or equal to the overdischarge cell voltage of the secondary battery included in the battery assembly module 13, the NPN transistor 154a of the power-off unit 154 is applied with the high level at the base to be in the ON state. When the NPN transistor 154a is put in the ON state, the low level is applied to the gate of the NMOS transistor 164c of the current cutoff unit 164 of the battery control unit 16, and accordingly, the NMOS transistor 164c is put in the OFF state. When the NMOS transistor 164c is put in the OFF state, the gate of the PMOS transistor 164d of the current cutoff unit 164 has the high impedance to be in the OFF state, and accordingly, the supply of power to the auxiliary machine group 26 is shut off.

Accordingly, when the cell voltage of the secondary battery included in the battery assembly module 13 is at less than or equal to the discharge termination cell voltage due to neglect of turning-off of the auxiliary machine group 26 such as a lamp, the supply of power to the auxiliary machine group 26 can be shut off, whereby an over discharge state of the secondary battery included in the battery assembly module 13 can be prevented.

Next, the operations will be described for a case where the operator performs key operation and the key switch 25 becomes the OFF state. When the key switch 25 is put in the OFF state, a key input signal of the low level is input from the forklift electrical system unit 12 to the key operation monitoring unit 163 of the battery control unit 16. When the key input signal is at the low level, the key operation monitoring unit 163 causes the relay 111 to be in the OFF state, and the supply of power from the battery pack module 14 to the inverter motor 22 through the first wiring W1 is shut off.

In addition, when the key input signal is at the low level, the NPN transistor 163d of the key operation monitoring unit 163 is continuously applied with the high level at the base by the PNP transistor 166c of the load current monitoring unit 166 and thus is maintained to be in the ON state. Accordingly, even when the key switch 25 is in the OFF state, when the auxiliary machine group switch 27 is in the ON state, power is supplied from the battery pack module 14 to the auxiliary machine group 26. In other words, even when the key switch 25 is put in the OFF state, and the inverter motor 22 is not put in a drivable state, the battery control unit 16 supplies the power of the battery pack module 14 to the auxiliary machine group 26.

Thereafter, when the battery voltage of the battery pack module 14 is at less than or equal to the discharge termination voltage and the voltage of the power supplied through the PMOS transistor 164d of the current cutoff unit 164 is lowered, the low level is applied to the gate of the NMOS transistor 164c of the current cutoff unit 164, and accordingly, the NMOS transistor 164c is put in the OFF state. When the NMOS transistor 164c is put in the OFF state, the PMOS transistor 164d is put in the OFF state as well, and the supply of power from the battery pack module 14 to the auxiliary machine group 26 is shut off. In other words, when the battery voltage of the battery pack module 14 is at less than or equal to the discharge termination voltage, the battery control unit 16 shuts off the supply of power to the auxiliary machine group 26.

In the electric forklift, the sub load unit such as a lamp or a horn is determined to be in the drivable state even when the key switch is in the OFF state, which is defined in the standard. Accordingly, in the electric forklift, a wiring branching from a main wiring that supplies power to the main load unit such as an inverter motor or a control unit is arranged, and power is supplied to the sub load unit, whereby the sub load unit can be driven even in a case where the key switch is in the Off state. However, when the sub load unit is continuously driven when the key switch is in the OFF state, the battery assembly used by the electric forklift as a drive power source is in the over discharge state, and there is a problem in that the battery assembly is degraded or broken down, and it is necessary to replace the battery assembly.

Thus, in this embodiment, by shutting off the supply of power to the auxiliary machine group 26 when the battery voltage of the battery pack module 14 is at less than or equal to the discharge termination voltage, the battery control unit 16 can shut off the supply of power to the auxiliary machine group 26 when the battery voltage of the battery pack module 14 is at less than or equal to the discharge termination voltage due to neglect of turning-off of the auxiliary machine group 26 such as a lamp, whereby the battery pack module 14 is prevented from being in the over discharge state.

Next, the operation for a case where the operator performs a key operation and the auxiliary machine group switch 27 is put in the OFF state will be described. When the auxiliary machine group switch 27 is put in the OFF state, a load current flowing into the auxiliary machine group 26 cannot be detected by the load current monitoring unit 166. When the load current is not detected, the PNP transistor 166c of the load current monitoring unit 166 is put in the OFF state.

When the PNP transistor 166c is put in the OFF state, the NPN transistor 163d and the PMOS transistor 163e of the key operation monitoring unit 163 are put in the OFF state, and accordingly, the battery voltage is not applied to the constant voltage circuit 165 from the battery pack module 14. Accordingly, a voltage is not applied to the power supply circuit 151 by the constant voltage circuit 165, and accordingly, the supply of power to the battery management unit 15 is shut off. In other words, when a load current is not detected, the battery control unit 16 shuts off the supply of power to the battery management unit 15.

Accordingly, the supply of power to the battery management unit 15 can be shut off without newly arranging a signal line that is used for transmitting a signal used for the notification of the Off state of the auxiliary machine group switch 27 to the battery pack device 11 from the forklift electrical system unit 12. In addition, when the auxiliary machine group switch 27 is put in the OFF state, power is not consumed in the battery management unit 15, and accordingly, the power consumption of the battery pack module 14 can be reduced.

Next, the operation for a case where the battery pack module 14 is charged by the charging unit 28 will be described. While the battery pack module 14 is charged by the charging unit 28, the battery management unit 15 detects the battery voltage of the battery pack module 14 and the cell voltage of the secondary battery included in the battery assembly module 13.

Then, when the detected battery voltage of the battery pack module 14 is at the maximum charging voltage or when the detected cell voltage is at the maximum charging cell voltage, the signal output unit 152 applies the low level to the gate of the PMOS transistor 152a so as to cause the PMOS transistor 152a to be in the ON state, whereby a state is formed in which a charge control signal for prohibiting the charging of the battery pack module 14 can be output. Here, when the secondary battery included in the battery assembly module 13 is a lithium ion battery, the signal output unit 152 outputs a charge control signal for prohibiting the charging of the battery pack module 14 through the output terminal 115.

As described above, according to the battery pack device 11 of this embodiment, in the relay 111 that is connected between the battery pack module 14 and the inverter motor 22 that is driven by being supplied with power from the battery pack module 14 and shuts off the supply of power from the battery pack module to the inverter motor 22 when the driving of the inverter motor 22 has been stopped, by forming a short circuit between the terminal 111b that is disposed on the side of the battery pack module 14 and the terminal 111c disposed on the side of the inverter motor 22, which are connected by the relay 111, while the driving of the inverter motor 22 has been stopped, the terminals 111b and 111c can be maintained at the same electric potential without arranging a pre-charging circuit while the driving of the inverter motor 22 is stopped. Accordingly, decreases in the size and the weight of the battery pack device 11 can be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply apparatus comprising:
a battery assembly;
a fuse element that is connected between the battery assembly and a load unit driven by being supplied with power from the battery assembly;
a switch unit that is connected in parallel to the load unit; and
a control unit that causes, when an over voltage of at least one of the battery assembly and the load unit is detected, the switch unit to be in an ON state, provides an over current to flow from the battery assembly to the fuse element, and fusing the fuse element.

2. The power supply apparatus according to claim 1, wherein
the switch unit includes two switches that are connected in series, and
the control unit detects a voltage between the switches, and detects an abnormality of the switch unit based on the detected voltage.

3. The power supply apparatus according to claim 1, wherein the switch unit is a relay having a primary coil that is connected to the battery assembly through the fuse element.

4. The power supply apparatus according to claim 3, further comprising a current limiting resistor that is connected between the switch unit and the fuse element and prevents an inrush current from flowing into the relay when the switch unit is in the ON state.

5. A power supply control apparatus comprising:
a relay that is connected between a secondary battery and a main load unit driven by being supplied with power from the secondary battery, and shuts off supply of power from the secondary battery to the main load unit when driving of the main load unit is stopped; and
a short circuit forming unit that forms, while the driving of the main load unit has been stopped, a short circuit between a first terminal and a second terminal of the relay, the first terminal being on a side of the secondary battery, the second terminal being on a side of the main load unit.

6. The power supply control apparatus according to claim 5, wherein the short circuit forming unit supplies power from the secondary battery to a sub load unit while the supply of power from the secondary battery to the main load unit through the relay has been stopped.

7. The power supply control apparatus according to claim 6, wherein the short circuit forming unit shuts off the supply of power from the secondary battery to the sub load unit when an over current is generated in the secondary battery.

8. The power supply control apparatus according to claim 7, further comprising a detection unit that is driven by the power supplied from the secondary battery to the sub load unit by the short circuit forming unit, and detects an occurrence of an over discharge state of the secondary battery, wherein
the short circuit forming unit shuts off the supply of power from the secondary battery to the sub load unit when the over discharge state of the secondary battery is detected by the detection unit.

9. A power supply apparatus comprising:
a secondary battery;
an output terminal that outputs a charge control signal to a charging unit that charges the secondary battery for a predetermined time from when the charge control signal is input, the charge control signal permitting charging the secondary battery; and
a signal output unit that is capable of converting, when a battery voltage of the secondary battery is at greater than or equal to a predetermined voltage at which the battery voltage is regarded as reaching an overcharged state, the charge control signal into a signal indicating prohibition of the charging of the secondary battery, and outputs the converted signal.

10. The power supply apparatus according to claim 9, wherein the output terminal continuously outputs the charge control signal permitting charging the secondary battery when the secondary battery is a lead storage battery.

11. A power supply apparatus comprising:
a battery assembly that supplies, when a main load unit is in a drivable state, power to the main load unit through a first wiring and to a sub load unit through a second wiring, the first wiring differing from the second wiring in system; and
a battery control unit that supplies, when the main load unit is not in the drivable state, power of the battery assembly to the sub load unit, and shuts off, when a battery voltage of the battery assembly is at less than or equal to a predetermined voltage at which the battery voltage is regarded as reaching an overcharged state, the supply of power of the battery assembly to the sub load unit.

12. The power supply apparatus according to claim 11, further comprising a battery management unit that is driven by being supplied with the power of the battery assembly, wherein
the battery control unit detects a load current flowing to the sub load unit, and shuts off the supply of power of the battery assembly to the battery management unit when the load current is not detected.

13. The power supply apparatus according to claim 12, wherein the battery management unit shuts off the supply of power to the sub load unit by the battery control unit when a cell voltage of a secondary battery of the battery assembly is at less than or equal to a predetermined voltage at which the cell voltage is regarded as reaching an over discharge state.
